(19) United States
(12) Patent Application Publication
(10) Pub. No.: US 2019/0070954 A1
(43) Pub. Date: Mar. 7, 2019

(54) FLOAT VALVE FOR FUEL TANK AND MANUFACTURING METHOD FOR THE SAME

(71) Applicant: KYOSAN DENKI CO., LTD., Koga-city (JP)

(72) Inventors: Yusuke MUKASA, Koga-city (JP); Nobuharu MUTO, Koga-city (JP)

(21) Appl. No.: 16/183,831

(22) Filed: Nov. 8, 2018

Related U.S. Application Data
(63) Continuation of application No. PCT/JP2017/005065, filed on Feb. 13, 2017.

(30) Foreign Application Priority Data
May 13, 2016 (JP) 2016-097342

(51) Int. Cl. B60K 15/035

(52) U.S. Cl. CPC B60K 15/03519

(57) ABSTRACT

A float valve for a fuel tank has a pipe. The pipe is arranged to protrude into the fuel tank from the upper part of the fuel tank. A main-float valve is arranged in the pipe. A sub-float valve is disposed in the pipe on the fuel tank side of the main-float valve. The pipe has a first case housing the main-float valve. The pipe has a second case connected via a coupling mechanism to a lower end of the first case. The second case accommodates the sub-float valve. The second case has a tubular portion extending in a height direction between the connecting mechanism and the sub-float valve. The tubular portion extends further downwardly beyond the lower end of the first case.

### CROSS REFERENCE TO RELATED APPLICATION

The present application is a continuation application of International Patent Application No. PCT/JP2017/005065 filed on Feb. 13, 2017, which designated the United States and claims the benefit of priority from Japanese Patent Application No. 2016-097342 filed on May 13, 2016. The entire disclosures of all of the above applications are incorporated herein by reference.

### TECHNICAL FIELD

The disclosure in this specification relates to a float valve provided in a ventilation path of a fuel tank.

### BACKGROUND

A float valve is known in this field, and is utilized to provide a fuel supply control valve.

### SUMMARY

It is a disclosed object to provide a float valve for a fuel tank and a manufacturing method thereof which can meet various requirements.

A float valve for a fuel tank is disclosed. The float valve comprises: a pipe which is disposed to project from an upper part of a fuel tank into the fuel tank so as to define an air passage from an inside of the fuel tank; a main-float valve which is disposed in the pipe, opens the air passage when there is no fuel in the pipe, and closes the air passage by floating on fuel that has reached the pipe; and a sub-float valve which is disposed in the pipe closer to the fuel tank than the main-float valve, and restricts an arrival of the fuel to the main-float valve by opening the air passage when the fuel is not present in the pipe and closing the air passage by floating on the fuel that has reached the pipe.

The pipe includes: a first case for housing the main-float valve; and a second case which is connected to a lower end of the first case via a connecting mechanism and accommodates the sub-float valve, the second case having a tubular portion extending in a height direction of the second case.

According to the float valve for a fuel tank disclosed herein, the second case has a tubular portion. The tubular portion extends in a height direction between the connecting mechanism and the sub-float valve. Therefore, by setting the height of the tubular portion, it is possible to adapt to various shapes of the fuel tank. As a result, it is possible to meet various requirements. From another viewpoint, it is possible to easily set the liquid surface height in the fuel tank.

A manufacturing method for a float valve for a fuel tank comprises: manufacturing a first case which accommodates the main-float valve and forms a part of the pipe; manufacturing a second case which is connectable to a lower end of the first case via a coupling mechanism, contains the sub-float valve, and forms a part of the pipe; and connecting the first case and the second case at the coupling mechanism.

The manufacturing the second case manufactures a plurality of the second cases having different heights between the connecting mechanism and the sub-float valve. The connecting the first case and the second case connects the second case selected from the plurality of the second cases having different heights to the first case.

According to the method for manufacturing a float valve for a fuel tank disclosed herein, a plurality of float valves for a fuel tank having different heights between the connecting mechanism and the sub-float valve are manufactured. Therefore, it is possible to manufacture a plurality of kinds of float valves for fuel tanks which can be adapted to various shapes of the fuel tank. As a result, it is possible to meet various requirements. From another viewpoint, it is possible to manufacture a float valve for a fuel tank which can easily set the liquid surface height in the fuel tank.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

### BRIEF DESCRIPTION OF DRAWINGS

FIG. 1 is a cross-sectional view of a float valve for a fuel tank according to a first embodiment,

FIG. 2 is a cross-sectional view of a fuel tank showing a first usage example of the first embodiment,

FIG. 3 is a cross-sectional view of a fuel tank showing a second usage example of the first embodiment,

FIG. 4 is a cross-sectional view of a fuel tank showing a second usage example of the first embodiment,

FIG. 5 is a cross-sectional view of a fuel tank showing a comparative example,

FIG. 6 is a cross-sectional view of a fuel tank showing a comparative example,

FIG. 7 is a cross-sectional view of a float valve for a fuel tank according to a second embodiment,

FIG. 8 is a cross-sectional view of a fuel tank showing a first usage example of the second embodiment,

FIG. 9 is a cross-sectional view of a fuel tank showing a second usage example of the second embodiment,

FIG. 10 is a cross-sectional view of a fuel tank showing a second usage example of the second embodiment, and

FIG. 11 is a cross-sectional view of a fuel tank showing a second usage example of the second embodiment.

### DESCRIPTION OF EMBODIMENTS

JP2013-82427A and JP2014-159209A disclose a float valve provided in a passage for ventilating a fuel tank. A refueling control valve which is one application of a float valve is disclosed. The refueling control valve is also called a fuel tank control valve for controlling a full tank (state in which the fuel has been supplied to the upper limit of the fuel tank). This device controls a ventilation of a fuel vapor generated in the fuel tank so as to encourage a stopping of a refueling device. The device comprises two valves for controlling ventilation. This device has a float valve which closes by floating on the fuel when the liquid fuel arrives and stops the ventilation. The refueling control valve and the float valve are attached to the upper wall surface of the fuel tank.

In the configuration of the prior art, the float valve is installed right under and close to a fueling control valve. Further, the position where the fuel supply control valve can be installed on the fuel tank is limited. Therefore, in the prior art, it has been difficult to realize various upper limit of the liquid level to satisfy various requirements. For example, in a case where the fuel tank has a complicated shape, if the fuel tank is inclined, there is a case that the required air amount cannot be secured. Conversely, in some cases, air is accumulated beyond the required amount of air, and it is sometimes impossible to refuel the required fuel amount. Further improvements are required for the fuel tank float valve in view of the above or other aspects not mentioned.

Hereinafter, a plurality of embodiments will be described with reference to the drawings. In some embodiments, parts that are functionally and/or structurally corresponding and/or associated are given the same reference numerals, or reference numerals with different hundred digit or more digits. For corresponding parts and/or associated parts, reference can be made to the description of other embodiments.

### First Embodiment

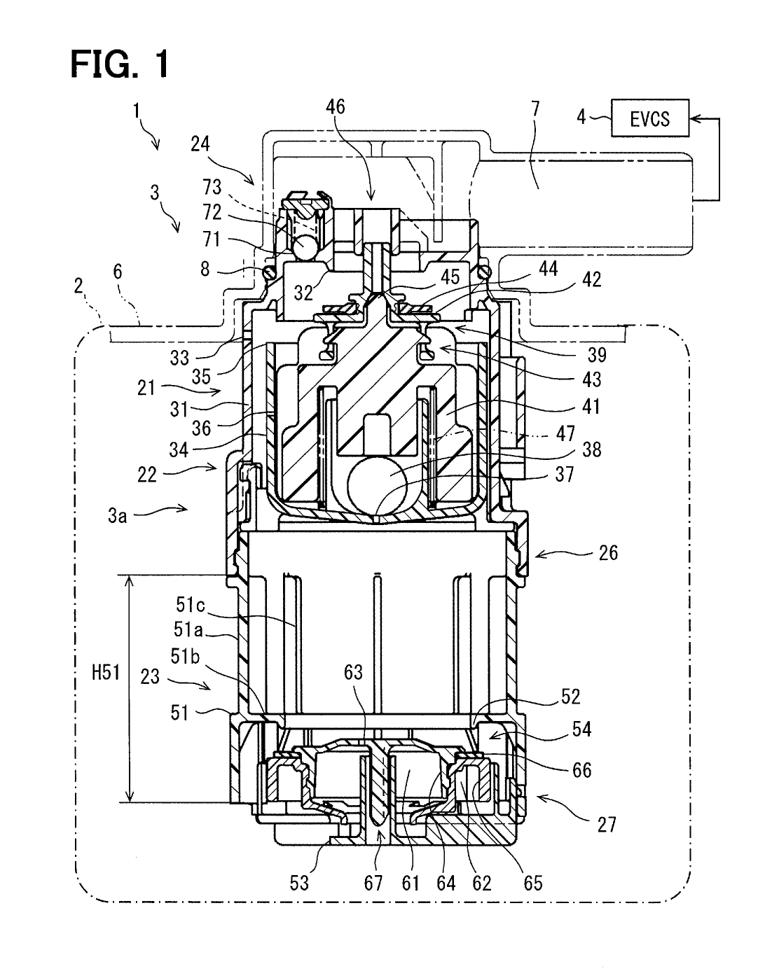

In FIG. 1, a fuel storage device 1 includes a fuel tank 2, a fuel supply control valve 3, and a fuel vapor treatment device (EVCS) 4. The fuel storage device 1 is mounted on a vehicle. The fuel storage device 1 may include a fuel supply device that supplies fuel to an internal combustion engine mounted on the vehicle. The fuel tank 2 is a container for storing liquid fuel. The fuel tank 2 has a complicated shape in order to provide a predetermined capacity while being mountable in a vehicle.

The fuel supply control valve 3 is provided in the fuel tank 2. The fuel supply control valve 3 may be provided in a fuel supply device provided in the fuel tank 2, for example, a pump module. The fuel supply control valve 3 provides a float valve for a fuel tank. The fuel supply control valve 3 is provided in an air passage for ventilation between the fuel tank 2 and the fuel vapor treatment device. The air passage is used for discharging the gas from the fuel tank 2 to the fuel vapor treatment device 4. The air passage is also called a ventilation passage or a breathing passage. The fuel supply control valve 3 opens and closes the air passage. The fuel supply control valve 3 is provided on an upper wall surface of the fuel tank 2.

The fuel supply control valve 3 permits ventilation between the fuel tank 2 and the fuel vapor treatment device 4 to permit refueling from the fuel supply port. The fuel supply control valve 3 cuts off the ventilation between the fuel tank 2 and the fuel vapor treatment device 4, thereby urging a stop of refueling from the fuel supply port. When the fuel supply control valve 3 shuts off ventilation, the liquid level of the fuel rises toward the fuel filler port. As a result, an automatic stopping mechanism (also referred to as an auto stop mechanism) of the fueling device reacts and the refueling from the fueling device is automatically stopped.

The fuel vapor treatment device 4 includes a canister for capturing fuel vapor (vapor) contained in the gas discharged from the fuel tank 2. The fuel vapor treatment device 4 includes a purge mechanism. When a predetermined condition is satisfied, the purge mechanism processes the fuel vapor by supplying the fuel vapor captured by the canister to the internal combustion engine for combustion.

The fuel supply control valve 3 is mounted on a flange 6 provided at an upper portion of the fuel tank 2. The flange 6 is made of resin or metal. The flange 6 is a member that covers an opening of the fuel tank 2. The flange 6 can be provided by a member dedicated for attaching the fuel supply control valve 3 or a member for attaching other fuel tank accessory parts. The fuel supply control valve 3 is disposed in the fuel tank 2 via the flange 6. The fuel supply control valve 3 hangs from the flange 6 into the fuel tank 2. The flange 6 defines a passage 7 between the fuel tank 2 and the fuel vapor treatment device 4. The fuel supply control valve 3 and the flange 6 are connected by a connecting mechanism such as a snap fit mechanism. An O-ring 8 as a seal member is provided between the oil supply control valve 3 and the flange 6. The fuel supply control valve 3 is installed so as to be in the illustrated position when the vehicle is in a horizontal state, i.e., when the fuel tank 2 is placed in a horizontal state.

The fuel supply control valve 3 has a tubular or a hollow cylindrical appearance extending downwardly from the upper part of the fuel tank 2. The fuel supply control valve 3 provides a tubular pipe 3a defined and formed by the members 31, 34, 51, 53 as a case. When the liquid level of the fuel tries to reach the upper end of the fuel tank 2, this pipe 3a enables the liquid level in the pipe 3a to climb upwardly, while the pipe 3a keeps an air space on the outside of the pipe 3a (the upper part of the fuel tank 2). The pipe 3a may also be referred to as a siphon pipe or an air chamber forming pipe. The upper end of the pipe 3a communicates with the passage 7, and the lower end thereof opens slightly below the upper end of the fuel tank 2. The pipe 3a hangs from the upper portion of the fuel tank 2 and defines an air passage. The fuel supply control valve 3 opens and closes the communication state between the fuel tank 2 and the passage 7 in response to the fuel liquid surface in the pipe 3a, that is, opens and closes the air passage.

The fuel supply control valve 3 has a main-float valve 21, a fuel retainer 22, a sub-float valve 23, and a relief valve 24.

The main-float valve 21 is arranged in the pipe 3a. The main-float valve 21 opens the air passage when there is no fuel in the pipe 3a. The main-float valve 21 floats on the fuel that reaches the inside of the pipe 3a and closes the air passage. The main-float valve 21 opens and closes the air passage in response to the fuel liquid surface (first liquid surface height) at a relatively upper portion of the pipe 3a.

The fuel retainer 22 provides a fuel reservoir for adjusting a response of the main-float valve 21. The fuel retainer 22 is also a responsivity adjustment mechanism for preventing frequent opening and closing such that the main-float valve 21 is opened again in a short period of time after the main-float valve 21 is once closed. The fuel retainer 22 maintains the main-float valve 21 in a closed state for a period that is assumed that the fuel supply operator will fill the fuel tank 2 and finish the refueling operation.

The sub-float valve 23 controls an arrival of fuel to the main-float valve 21. The sub-float valve 23 prevents the fuel from reaching the main-float valve 21 even if the temporary fuel level rises. On the other hand, the sub-float valve 23 permits the fuel to reach the main-float valve 21 when the fuel level continually rises. The sub-float valve 23 is disposed in the pipe 3a closer to the fuel tank 2 than the main-float valve 21. The sub-float valve 23 is arranged at the lower part of the pipe 3a, i.e., near the inlet. The sub-float valve 23 opens the air passage when there is no fuel in the pipe 3a. The sub-float valve 23 floats on the fuel that has reached the inside of the pipe 3a and closes the air passage. As a result, the sub-float valve 23 limits the arrival of the fuel to the main-float valve 21. The sub-float valve 23 opens and closes the passage in the pipe 3a, i.e., the air passage between the inlet of the pipe 3a and the main-float valve 21 in response to the fuel liquid surface at the inlet of the pipe 3a.

The relief valve 24 suppresses a pressure in the fuel tank 2. The relief valve 24 opens when the pressure in the fuel tank 2 becomes excessively high and discharges the gas in the fuel tank 2 to the passage 7.

The main-float valve 21 has a first case 31. The first case 31 is a tubular shape or a hollow cylindrical shape. The upper end of the first case 31 is connected to the flange 6. An opening is provided at the upper end of the first case 31 to communicate the inside of the fuel tank 2 with the passage 7. The opening is surrounded and defined by a first valve seat 32. An opening communicating with the fuel tank 2 is provided at a lower end of the first case 31. At the lower end of the first case 31, the sub-float valve 23 is provided. The lower end of the first case 31 is opened and closed by the sub-float valve 23. A through hole 33 is provided at a predetermined position of the upper portion of the first case 31. The through hole 33 communicates the inside and the outside of the first case 31. The through hole 33 enables discharge of fuel from the upper part of the first case 31 and/or supply of air to the upper part of the first case 31.

The fuel retainer 22 has an inner cup 34. The inner cup 34 is accommodated in the first case 31. The inner cup 34 is in a cup shape capable of storing fuel. The inner cup 34 defines a fuel reservoir in the first case 31. An upper end opening 35 of the fuel reservoir provided by the inner cup 34 is located at substantially the same height as the through hole 33. The inner cup 34 is formed so as to introduce and store fuel from the upper end opening 35. The inner cup 34 is held by being sandwiched between the first case 31 and a second case 51 described later.

The inner cup 34 has a through hole 36 provided on the side wall and a through hole 37 provided on the bottom wall. The through hole 36 allows the fuel to be discharged from the fuel reservoir in the inner cup 34. The through hole 36 slowly exhausts the fuel. The through hole 36 is set to be small so as to cause the fuel to slowly leaking over a relatively long period of time, which is predicted that the operator of the fueling device 5 will give up the supplementary refueling. The bottom wall of the inner cup 34 is formed so as to provide a funnel-shaped bottom surface inside. The through hole 37 is opened at the lowermost position of the bottom wall. The through hole 37 is formed to be relatively large so as to discharge the fuel rapidly. The inner cup 34 provides a member forming a fuel reservoir for storing fuel to maintain the main float valve 21 in a closed state.

The main-float valve 21 has a ball 38. The ball 38 can close the through hole 37. In addition, the ball 38 can open the through hole 37 by rolling while sensing a rolling. Instead of the ball 38, various members such as a roller and a thin piece for sensing a rolling can be used. The inner cup 34 and the ball 38 provide the fuel retainer 22. The inner cup 34 and the ball 38 provide a discharge valve for discharging the fuel in the inner cup 34 during the period after the refueling operation is completed. The ball 38 rolls by sensing the rolling of the fuel tank 2, i.e., the rolling caused by the running of the vehicle. The through holes 36, 37 and the ball 38 provide a discharge mechanism for discharging fuel from the fuel reservoir provided by the inner cup 34. The discharge mechanism holds the fuel so as to prevent excessive refueling in a single refueling operation, but enables refueling again after the refueling operation is completed. The through hole 37 and the ball 38 provide the mechanism which determines a completion of the single refueling operation and discharges the fuel.

The main-float valve 21 has a movable valve body 39. The movable valve element 39 is accommodated in the first case 31. The movable valve body 39 is accommodated in the inner cup 34. The movable valve element 39 is accommodated so as to be movable in the first case 31 and the inner cup 34 in the axial direction, i.e., along the vertical direction.

The movable valve element 39 is structured so as to float on the fuel when there is fuel in the inner cup 34. The movable valve element 39 has a float 41. The float 41 is accommodated in the inner cup 34. The movable valve body 39 has a holder 42. The holder 42 is arranged on the float 41. The holder 42 is connected to the float 41 via a coupling mechanism 43. The coupling mechanism 43 is provided by a protrusion provided on the float 41 and a hook part provided on the holder 42 and having an elongated slot in the height direction for receiving the protrusion. A certain amount of play is permitted by movement of the protrusion in the slot of the hook part. The coupling mechanism 43 connects the float 41 and the holder 42 so that the float 41 and the holder 42 can be separated by a predetermined amount in the axial direction.

The holder 42 holds a seal member 44. The seal member 44 is an annular plate. The seal member 44 is tightly fitted in a hollow cylindrical portion of the holder 42. The holder 42 and the seal member 44 block communication between the fuel tank 2 and the passage 7 when the movable valve element 39 is seated on the valve seat 32, i.e., when the seal member 44 is seated on the valve seat 32. When the seal member 44 is seated on the valve seat 32, the closed state of the main-float valve 21 is provided. As the seal member 44 separates from the valve seat 32, the open state of the main-float valve 21 is provided.

A pilot valve 45 for assisting opening of the main-float valve 21 is formed between the float 41 and the holder 42. The float 41 has a hemispherical protrusion. The holder 42 has a seat surface for receiving the protrusion. The pilot valve 45 is opened and closed by the play provided by the coupling mechanism 43. When the seal member 44 is seated on the valve seat 32, the pressure in the fuel tank 2 becomes higher than the pressure in the passage 7. When the float 41 descends due to lowering of the fuel level, the coupling mechanism 43 allows the float 41 to be separated from the holder 42. As a result, the pilot valve 45 opens. When the pilot valve 45 opens, the pressure difference between the front and the rear of the seal member 44 is relaxed, and the seal member 44 becomes easy to separate from the valve seat 32.

The float 41 is guided in the inner cup 34 in the vertical direction, i.e., in the axial direction. The inner cup 34 provides an inner hollow cylinder and an outer hollow cylinder for guiding the float 41. Furthermore, a guide mechanism 46 is provided between the holder 42 and the first case 31. The guide mechanism 46 is provided by a small-diameter hollow cylinder portion provided in the holder 42 and a large-diameter hollow cylinder portion provided in the first case 31. By disposing the small-diameter hollow cylinder portion in the large-diameter hollow cylinder portion, the holder 42 is guided so as to be movable in the axial direction without being displaced in the radial direction. A spring 47 in a compressed state is disposed between the inner cup 34 and the float 41. The spring 47 urges the movable valve body 39 upward. The spring 47 compensates a buoyancy of the movable valve body 39.

The first case 31, the inner cup 34, the float 41, and the holder 42 are made of resin. The ball 38 is made of resin. The seal member 44 is made of rubber.

The sub-float valve 23 has a second case 51. The second case 51 is a tubular shape or a hollow cylindrical shape. The second case 51 is attached to the lower end opening of the first case 31. The first case 31 and the second case 51 are connected. In this embodiment, the first case 31 and the second case 51 are connected by a connecting mechanism 26. The connecting mechanism 26 is provided by an engagement mechanism utilizing elastic deformation between the first case 31 and the second case 51. The connecting mechanism 26 is also called a snap fit.

The sub-float valve 23 has a third case 53. The third case 53 has a shallow dish shape. The third case 53 is attached to the lower end opening of the second case 51. The second case 51 and the third case 53 are connected by a connecting mechanism 27. The connecting mechanism 27 is provided by an engagement mechanism utilizing elastic deformation between the second case 51 and the third case 53. The connecting mechanism 27 is also called a snap fit.

The third case 53 forms a receiving chamber for the movable valve element 54 between the second case 51 and the third case 53 while forming an opening at the lower end of the second case 51. The receiving chamber communicates with the interior of the fuel tank 2 via a large opening at the lower end. Therefore, the fuel in the fuel tank 2 can freely enter the room partitioned by at least the second case 51 and the third case 53.

The sub-float valve 23 has a movable valve body 54. The movable valve body 54 has a flat hollow cylindrical shape. The movable valve element 54 is accommodated between the second case 51 and the third case 53. The movable valve body 54 is seated on or is separated from the second valve seat 52 by floating on the fuel in the fuel tank 2. The movable valve body 54 defines a plurality of air reservoirs 61, 62. In the plurality of air reservoirs 61, 62, since the movable valve body 54 floats on the fuel, air is stored under the liquid level of the fuel. The plurality of air reservoirs 61, 62 include a first air reservoir 61 and a second air reservoir 62. The plurality of air reservoirs 61 and 62 provide buoyancy chambers for allowing the movable valve body 54 to float on the fuel when the fuel reaches the movable valve body 54. These air reservoirs 61 and 62 are partitioned by a cap-shaped member opened downward.

The first air reservoir 61 is disposed at a radially center portion of the movable valve body 54. The first air reservoir 61 is arranged so as to occupy the center portion in the radial direction of the movable valve body 54. The first air reservoir 61 is disposed on an upper portion of the movable valve body 54. The first air reservoir 61 reserves the air under the fuel liquid level in order to float the movable valve body 54 on the fuel.

The first air reservoir 61 has a buoyancy reducing part for gradually decreasing the buoyancy applied to the movable valve body 54 as time elapses after the fuel reaches the movable valve body 54. The movable valve body 54 has a through hole 63 for gradually reducing the buoyancy. The through hole 63 provides a buoyancy reducing part for gradually reducing the buoyancy by removing air from the first air reservoir 61 and introducing fuel into the first air reservoir 61. The buoyancy reducing part gradually sinks the movable valve body 54 into the fuel.

The second air reservoir 62 is disposed at a radially outer portion of the movable valve body 54. The second air reservoir 62 is disposed at a position that can be called a center portion or a lower portion of the movable valve body 54 in the vertical direction. The second air reservoir 62 is disposed radially outward of at least a part of the first air reservoir 61. The second air reservoir 62 is arranged so as to surround at least a part of the first air reservoir 61. The second air reservoir 62 does not have a buoyancy reducing part such as the through hole 63. The second air reservoir 62 has a plurality of small chambers. The plurality of small chambers are distributedly arranged along the circumferential direction. The second air reservoir 62 is annularly arranged along the second valve seat 52, and each of the small chambers can hold air independently. The second air reservoir 62 is annularly arranged along the outer periphery of the movable valve body.

The movable valve body 54 includes a first member 64 and a second member 65. The first member 64 provides an upper portion and a middle portion of the movable valve body 54. The first member 64 may also be referred to as an upper member or an inner member. The first member 64 is a tubular shape or a hollow cylindrical shape. The first member 64 has a cap shape having a lower end opening portion at a lower end. The first member 64 has a through hole 63 on an upper wall. The through hole 63 opens into the opening surrounded by the second valve seat 52. The second member 65 provides a lower part and an outer peripheral part of the movable valve element 54. The second member 65 may also be referred to as a lower member or an outer member. The second member 65 is an annular shape. The first member 64 is disposed radially inward of the second member 65.

The first member 64 and the second member 65 provide a forming member for defining the plurality of air reservoirs 61 and 62. In particular, the second member 65 provides a forming member for defining a plurality of air chambers of the second air reservoir 62. The first member 64 defines the through hole 63 as the buoyancy reducing part. The first member 64 and the second member 65 are connected by a connecting mechanism such as a snap fit. The first member 64 and the second member 65 can be connected by various connecting methods such as adhesion or welding. The first member 64 and the second member 65 are made of resin.

The movable valve body 54 has a seal member 66. The seal member 66 is disposed on the upper surface of the movable valve body 54. The seal member 66 is fixed between the first member 64 and the second member 65, which are forming members. The seal member 66 seats or separates from the second valve seat 52. When the movable valve body 54 moves upward as it floats on the fuel, the seal member 66 is seated on the second valve seat 52. The sealing member 66 closes the air passage by seating on the second valve seat 52. When the movable valve body 54 moves downward as the movable valve body 54 sinks into the fuel or the liquid level of the fuel falls, the seal member 66 is separated from the second valve seat 52. The sealing member 66 opens the air passage by lifting away from the second valve seat 52. The movable valve body 54 is guided by the guide mechanism 67 so as to move in the vertical direction, i.e., in the axial direction. The guide mechanism 67 provides stable contact between the second valve seat 52 and the seal member 66.

The relief valve 24 is provided on the upper wall of the first case 31. The relief valve 24 has a valve seat 71, a movable valve element 72, and a spring 73. A relief pressure is set by the movable valve element 72 and the spring 73.

Returning to the second case 51, the second case 51 has a tubular portion 51a. The tubular portion 51a extends further downward beyond the lower end of the first case 31 at least in the height direction. The cylindrical portion 51a is provided between the connecting mechanism 26 and the sub-float valve 23. The tubular portion 51a is formed by a hollow cylinder as a simple passage which does not accommodate the sub-float valve 23 therein. The second case 51 has a partition wall 51b. The partition wall 51b is provided inside the second case 51. The partition wall 51b defines the lower end of the tubular portion 51a. The partition wall 51b is provided at an end portion of the tubular portion 51a which communicates with the fuel tank 2. In other words, the tubular portion 51a is provided between the connecting mechanism 26 and the partition wall 51b. The partition wall 51b is positioned further below the lower end of the first case 31.

The partition wall 51b has an opening for communicating the inside of the fuel tank 2 and the inside of the first case 31. The opening is surrounded and defined by the second valve seat 52. The second valve seat 52 is positioned on an upstream side of the first valve seat 32 with respect to the air flow direction in the fuel supply control valve 3. In other words, the second valve seat 52 is installed inside the fuel tank 2 more than the first valve seat 32. The second valve seat 52 is located further below the lower end of the first case 31. The opening formed by the second valve seat 52 is larger than the opening formed by the first valve seat 32. The diameter of the opening formed by the second valve seat 52 is larger than the radius of the first case 31.

The second case 51 has a plurality of ribs 51c. The plurality of ribs 51c are provided in the tubular portion 51a of the second case 51. The plurality of ribs 51c are provided on the inner surface of the second case 51. The plurality of ribs 51c protrude radially inward from the inner surface of the second case 51. The plurality of ribs 51c are elongated plate-like shapes extending along the axial direction of the second case 51. The plurality of ribs 51c are radially arranged on the inner surface of the second case 51. The plurality of ribs 51c extend between the radially inner portion of the connecting mechanism 26 and the partition wall 51b. The plurality of ribs 51c reinforce the second case 51. Further, a part of the plurality of ribs 51c extends to a lower side of the partition wall 51b. Thereby, the plurality of ribs 51c reinforce the partition wall 51b.

The second case 51 is a member for adjusting the position of the opening end of the pipe 3a in the fuel tank 2. The second case 51 is used for adjusting the height of at least the pipe 3a. The second case 51 is a member for adjusting the height of the pipe 3a provided by the fuel supply control valve 3. The second case 51 is a member for adjusting the installation position of the sub-float valve 23. The second case 51 makes it possible to position the sub-float valve 23 at a position distant from the main-float valve 21. The second case 51 is given a predetermined height so as to position the sub-float valve 23 at a desired height position in the fuel tank 2. The sub-float valve 23 defines an upper limit of the fuel level in the fuel tank 2. Therefore, the second case 51 that defines the position of the sub-float valve 23 is a member for setting the upper limit of the fuel level in the fuel tank 2.

The second case 51 has a height H51 in the height direction. The height H51 is the distance between the lower end opening of the first case 31 and the lower end opening of the second case 51. The second case 51 has a tubular portion for exclusively functioning as the pipe 3a which is provided between the lower end of the first case 31 and the sub-float valve 23, or is provided between the connecting mechanism 26 and the sub-float valve 23.

The second case 51 is a component for height adjustment in the fuel supply control valve 3. The second case 51 is the only part for adjusting the height. The manufacturer sets the height of the second case 51 according to the shape of the fuel tank 2 to which the fuel supply control valve 3 is applied. As a result, it is possible to manufacture the fuel supply control valve 3 having characteristics that can realize a required upper limit of the fuel level.

In one example, the method of manufacturing the fuel supply control valve 3 includes a step of setting a shape, e.g., a height of the second case 51 so as to conform to the shape of the fuel tank 2. Here, the height is set so that the second valve seat 52 is positioned further below the lower end of the first case 31. The manufacturing method includes a step of manufacturing the second case 51 having one kind of height. In a subsequent stage, one type of second case 51 is connected to the first case 31. By this manufacturing method, one kind of fuel supply control valve 3 having a single height is manufactured.

In another example, the method for manufacturing the fuel supply control valve 3 includes a step of setting a shape, e.g., heights of various types of second cases 51 so as to conform to the shapes of the various types of fuel tanks 2. Here, the height is set so that the second valve seat 52 is positioned further below the lower end of the first case 31. The manufacturing method includes a step of manufacturing multiple types of second cases 51 having a plurality of different heights. In a subsequent stage, the second type of case 51 is selectively connected to the first case 31. The manufacturing method includes a step of selecting the second case 51 to be connected to the first case 31 from among various types. By this manufacturing method, various kinds of fuel supply control valves 3 are manufactured. By this manufacturing method, the fuel supply control valves 3 having different characteristics are manufactured.

The manufacturing method includes a step of manufacturing the first case 31 that accommodates the main-float valve 21. The manufacturing method includes a step of manufacturing the second case 51 that can be connected to the lower end of the first case 31 by the connecting mechanism 26 and accommodates the sub-float valve 23. Furthermore, the manufacturing method has a step of connecting the first case 31 and the second case 51 at the connecting mechanism 26. In the step of manufacturing the second case 51, a plurality of the second cases are manufactured the plurality of the second cases may be categorized into some groups having different heights H51 between the connecting mechanism 26 and the sub-float valve 23. For example, one kind of the second case 51 having the height H51, which is zero, and the other kind of the second case 51 having the height H51, which is some centimeters, are manufactured. In the step of connecting the first case 31 and the second case 51, the second case 51 is selected from the plurality of the second cases 51 having different heights, and the selected second case 51 is connected to the first case 31. In the step of manufacturing the first case 31, a common first case 31 is manufactured for a plurality of different second cases 51. The common first case 31 contributes to improvement of productivity.

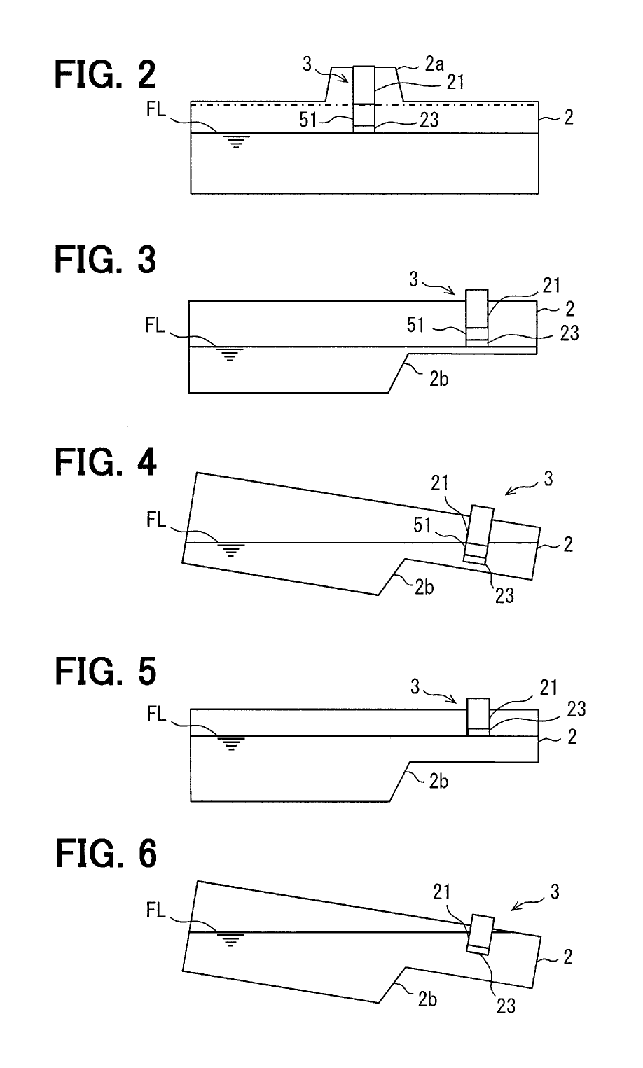

FIG. 2 shows a first usage example of the fuel supply control valve 3. The fuel tank 2 has a protruding portion 2a on its upper surface. The fuel supply control valve 3 is provided on the upper end face of the protrusion 2a. If there is no second case 51, the fuel is refueled to the dash-dotted line level. In this case, a sufficient air volume can not be secured in the fuel tank 2.

The fuel supply control valve 3 of this embodiment has the second case 51. As a result, the fuel supply control valve 3 allows the fuel to be supplied to the liquid level FL shown in the fuel tank 2. The second case 51 adjusts the height of the sub-float valve 23 in the fuel tank 2. By positioning the sub-float valve 23 at an appropriate height, it is possible to cause the automatic stop of the fueling device on the appropriate liquid level FL. As a result, a necessary air volume is secured in the fuel tank 2.

FIG. 3 and FIG. 4 show a second usage example of the fuel supply control valve 3. The fuel tank 2 has an uneven wall 2b on its bottom surface. As a result, the fuel tank 2 has an asymmetric shape. The fuel in the fuel tank 2 forms liquid surfaces in different heights for each inclination direction, since the fuel is affected by the bottom surface.

Further, the fuel supply control valve 3 is not provided on a center portion of the fuel tank 2. In other words, the fuel supply control valve 3 is not provided at a position where an average liquid level with little influence in the inclination direction is observed. The fuel supply control valve 3 is provided at an end portion of the fuel tank 2. The fuel supply control valve 3 is provided on a relatively shallow portion provided by the uneven wall 2b. Such an installation position occurs due to various causes. For example, due to the shape of the fuel tank 2 or due to the laying position of the air passage 7 in the vehicle, a somewhat offset arrangement as shown may be required. According to this embodiment, the fuel supply control valve 3, which is disposed on a position of the fuel tank 2 where the liquid level variation caused by the inclination is large, is provided.

FIG. 3 shows a case where the fuel tank 2 is in a normal attitude. When the fuel is supplied to the fuel tank 2, the supply of fuel is stopped at the liquid level FL by the function of the sub-float valve 23. In this state, a desirable air volume is secured in the fuel tank 2.

FIG. 4 shows a case where the fuel tank 2 is inclined. The fuel tank 2 is inclined so that a shallow part is positioned downward and a deep part is positioned upward. When the fuel tank 2 is tilted as shown in FIG. 4 after having been supplied to the liquid surface FL in FIG. 3, the liquid surface FL approaches the upper wall of the fuel tank 2 in the vicinity of the fuel supply control valve 3. In addition, due to the uneven wall 2b, the liquid level FL reaches close to the upper wall.

The second case 51 separates the main-float valve 21 and the sub-float valve 23 from each other in the height direction by a distance equal to or greater than the distance in a case of directly stacking them. In other words, the second case 51 gives a sufficient difference between the liquid level at which the sub-float valve 23 is closed and the liquid level at which the main-float valve 21 sinks below the liquid level and is closed. As a result, even if the liquid level FL rises in a vicinity of the fuel supply control valve 3, the main-float valve 21 is prevented from sinking below the liquid level. Immersion in the liquid surface of the main-float valve 21 is avoided in a range below a predetermined inclination angle. As a result, even if the liquid level fluctuation is caused by the inclination of the fuel tank 2, closing of the main-float valve 21 is suppressed. In other words, it is possible to maintain the valve opening state of the main-float valve 21 in a range equal to or less than the predetermined inclination angle.

According to this embodiment, continuous closing of the main-float valve 21 due to a temporary inclination of the fuel tank 2 is avoided. Further, even if the fuel tank 2 is continuously inclined, such as when the vehicle is parked in an inclined state, the main-float valve 21 can be placed in the open state in a range below a predetermined inclination angle. As a result, it is possible to avoid problems such as an excessive increase in pressure in the fuel tank 2.

FIG. 5 and FIG. 6 show a comparative example in which the second case 51 is short. In the comparative example, the main-float valve 21 and the sub-float valve 23 are arranged in a directly stacked manner. When the fuel tank 2 is inclined as shown in FIG. 6 after being supplied the fuel to the liquid level FL shown in FIG. 5, the main-float valve 21 sinks under the liquid surface at a relatively small inclination angle. In this case, the communication between the inside of the fuel tank 2 and the air passage 7 is interrupted at a relatively small inclination angle.

According to the embodiment described above, the position of the opening end of the pipe 3a can be set by the second case 51. The second case 51 makes it possible to position the open end of the pipe 3a further below the lower end of the first case 31. The height of the pipe 3a can be set exclusively by the second case 51. Therefore, by changing only the second case 51, which is a part of the components of the fuel supply control valve 3, the position of the opening end of the pipe 3a can be changed. The position of the open end of the pipe 3a is also the position of the sub-float valve 23. Therefore, according to this embodiment, by changing the shape of only the second case 51, the position of the sub float valve 23 can be set. The second case 51 makes it possible to position the sub-float valve 23 further below the lower end of the first case 31.

### Second Embodiment

This embodiment is a modification in which the preceding embodiment is a fundamental form. In the above embodiment, the height of the opening of the pipe 3a is adjusted by the second case 51. Alternatively, in this embodiment, a position of the opening in the horizontal direction of the pipe 3a is also adjusted. A second case 251 disclosed in this embodiment can be replaced with the second case 51 of the preceding embodiment.

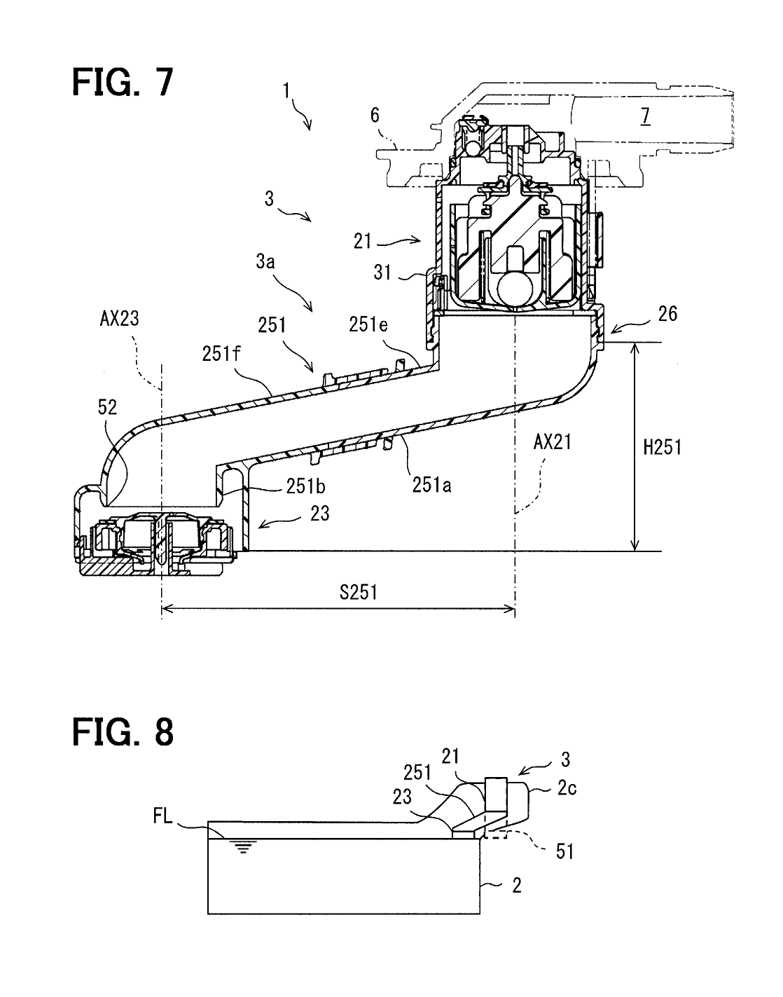

As shown in FIG. 7, the main-float valve 21 and the first case 31 are the same as in the preceding embodiment. The fuel supply control valve 3 has the second case 251. The second case 251 is a tubular shape or a hollow cylinder shape. The second case 251 has a cylindrical portion 251a and a partition wall 251b. Also in this embodiment, the tubular portion 251a is provided by a simple tube that does not accommodate the sub-float valve 23. The partition wall 251 b is located below the lower end of the first case 31.

The second case 251 extends obliquely with respect to the direction of gravity. The second case 251 has one end connected to the first case 31. The second case 251 has the other end accommodating the sub-float valve 23. One end is positioned higher than the other end. The other end is positioned lower than one end. The tubular portion 251a extends further downwardly beyond the lower end of the first case 31. The second case 251 positions the opening end of the pipe 3a lower than the opening end of the first case 31 by a height H251. Further, the second case 251 positions the open end of the pipe 3a at a position shifted from the center axis AX21 of the main-float valve 21 in the horizontal direction by a distance S251. In other words, the central axis AX21 of the main-float valve 21 and the central axis AX23 of the sub-float valve 23 are shifted in the horizontal direction by the distance S251. The second case 251 makes it possible to position the lower end opening of the pipe 3a and/or the sub-float valve 23 at the desired position in the fuel tank 2.

The second case 251 includes a first member 251e and a second member 251f. The first member 251e and the second member 251f are connected to each other to provide a series pipe of the pipe 3a. The second case 251 may be supported by the flange portion 6.

Also in this embodiment, the method for manufacturing a float valve for a fuel tank may include a step of manufacturing different second cases 251. For example, in the manufacturing method, it is possible to manufacture a plurality of types of second cases 251 having different lengths of the tubular portion 251a. In addition, in the manufacturing method, it is possible to manufacture a plurality of types of second cases 251 having different amounts of lateral displacement by the cylindrical portion 251a. In the manufacturing process of the second case 251 in the manufacturing method, a plurality of second cases 251 having different distances S251 between the central axis AX1 of the main-float valve 21 and the central axis AX2 of the sub-float valve 23 are manufactured. The second case of one type may be the second case 51 of the preceding embodiment. The distance between the center axis AX1 and the center axis AX2 in the second case 51 is zero.

FIG. 8 shows a first usage example of the fuel supply control valve 3. In the drawing, the second case 51 of the preceding embodiment is illustrated by a broken line. The fuel tank 2 has a protruding portion 2c extending obliquely upward from a main volume portion. The fuel supply control valve 3 is arranged so as to protrude into the fuel tank 2 from the upper wall of the protruding portion 2c.

As shown by the broken line, when using the second case 51 of the preceding embodiment, the fuel supply control valve 3 interferes with the lower wall of the protruding portion 2c. In this case, the fuel supply control valve 3 can not be installed. On the other hand, according to the fuel supply control valve 3 of this embodiment, the second case 251 positions the lower end opening of the pipe 3a and/or the sub-float valve 23 at a position shifted from the main-float valve 21. The second case 251 positions the lower end opening of the pipe 3a and/or the sub-float valve 23 above the main portion, e.g., the relatively deep portion of the fuel tank 2. As a result, the fuel supply control valve 3 makes it possible to form an appropriate liquid level FL.

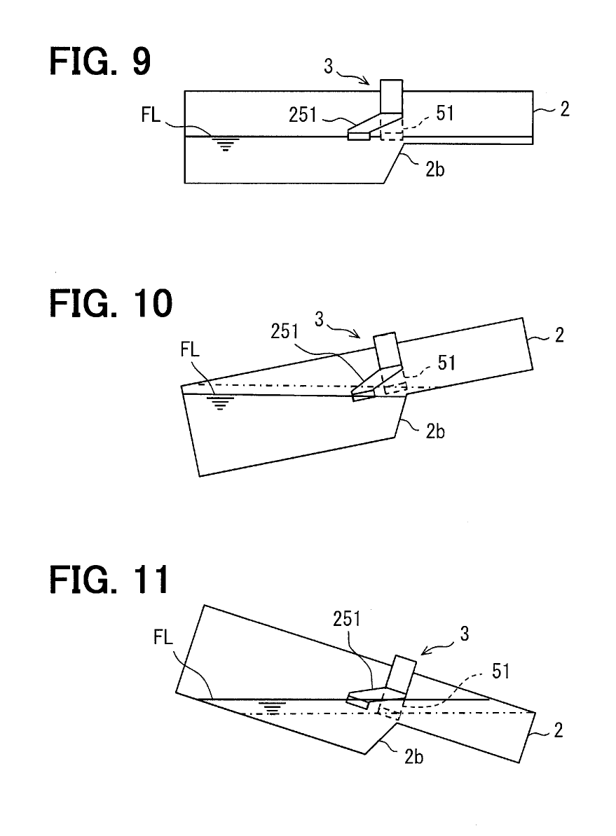

FIG. 9, FIG. 10 and FIG. 11 show a second usage example of the fuel supply control valve 3. In the drawing, the second case 51 of the preceding embodiment is illustrated by a broken line. The fuel tank 2 has an uneven wall 2b on its bottom surface. As a result, the fuel tank 2 has an asymmetric shape. The fuel in the fuel tank 2 forms liquid surfaces in different heights for each inclination direction, since the fuel is affected by the bottom surface. The fuel tank 2 has an uneven wall 2b convex to an inside at a position offset to the right side in the drawing. The fuel supply control valve 3 is disposed at a position offset slightly to the right of the central portion of the fuel tank 2. Therefore, the liquid level immediately below the fuel supply control valve 3 fluctuates relatively largely according to the inclination of the fuel tank 2. On the other hand, the liquid level slightly to the left of the fuel supply control valve 3 varies relatively small even if the inclination of the fuel tank 2 changes. In the second case 251, the lower end opening of the pipe 3a and/or the sub-float valve 23 is installed in a position where the liquid level variation relative to the inclination angle in the fuel tank 2 is comparatively small.

As shown in FIG. 9, when the fuel tank 2 is in a regular posture, the fuel supply control valve 3 permits refueling up to a regular liquid level FL.

When the fuel tank 2 is inclined as shown in FIG. 10, the fuel forms a relatively low liquid level. The second case 251 positions the lower end opening of the pipe 3a and/or the sub-float valve 23 at a position shifted from the main-float valve 21. Here, the second case 251 positions the lower end opening of the pipe 3a and/or the sub-float valve 23 on a relatively deep portion in the fuel tank 2. As a result, the fuel supply control valve 3 makes it possible to form an appropriate liquid level FL. When the second case 51 is provided without including the second case 251, a liquid surface that is too high as indicated by an alternate long and short dashed line may be formed in the fuel tank 2 in some cases.

When the fuel tank 2 is inclined as shown in FIG. 10, the fuel forms a relatively high liquid level. The second case 251 makes it possible to form an appropriate liquid level FL. In the case where the second case 51 is provided without the second case 251, an excessively low liquid level as indicated by an alternate long and short dashed line may be formed in the fuel tank 2 in some cases.

According to the embodiment described above, the lower end opening of the pipe 3a and/or the position of the sub-float valve 23 can be set by the second case 251. As a result, a difference in liquid level variation caused by the shape of the fuel tank 2 and/or the installation position of the fuel supply control valve 3 in the fuel tank 2 is corrected to form a liquid level FL of a desired height.

### Other Embodiments

The disclosure in this specification is not limited to the illustrated embodiment. The disclosure encompasses the illustrated embodiments and modifications by those skilled in the art based thereon. For example, the disclosure is not limited to the parts and/or combinations of elements shown in the embodiments. The disclosure can be implemented in various combinations. The disclosure may have additional parts that may be added to the embodiment. The disclosure encompasses omissions of parts and/or elements of the embodiments. The disclosure encompasses replacement or combination of parts and/or elements between one embodiment and another. The disclosed technical scope is not limited to the description of the embodiment. Several technical scopes disclosed are indicated by descriptions in the claims and should be understood to include all modifications within the meaning and scope equivalent to the descriptions in the claims.

In the above embodiments, the fuel supply control valve 3 is provided with the relief valve 24. Alternatively, it is also possible to adopt a configuration in which the fuel supply control valve 3 does not include the relief valve 24. Also, the fuel supply control valve 3 itself may be configured to form an assembly with other parts.

In the above embodiments, a fuel reservoir is formed in the first case 31 by the inner cup 34. Alternatively, the inner cup 34 may be formed integrally with the first case 31 or the second case 51. Further, in the above embodiments, the sub-float valve 23 is disposed under the main-float valve 21. Alternatively, the sub-float valve 23 may be disposed beside the main-float valve 21. Even with this configuration, the arrival of fuel to the main-float valve 21 can be controlled by the sub-float valve 23. Further, in the above embodiment, a snap fit for engaging parts by utilizing the elasticity of resin parts for connection or connection of members is utilized. Alternatively, various connecting methods, such as adhesion with an adhesive, welding for melting a part of the member, connection with a fastening member such as a bolt, thread coupling and the like can be used. In this way, the members 31, 34, 51, and 52 as the cases can adopt various shapes to provide the functional elements found in the configuration of the embodiments.

What is claimed is:

1. A float valve for a fuel tank, the float valve comprising:
a pipe which is disposed to project from an upper part of a fuel tank into the fuel tank so as to define an air passage from an inside of the fuel tank;
a main-float valve which is disposed in the pipe, opens the air passage when there is no fuel in the pipe, and closes the air passage by floating on fuel that has reached the pipe; and
a sub-float valve which is disposed in the pipe closer to the fuel tank than the main-float valve, and restricts an arrival of the fuel to the main-float valve by opening the air passage when the fuel is not present in the pipe and closing the air passage by floating on the fuel that has reached the pipe, wherein
the pipe includes:
a first case for housing the main-float valve; and
a second case which is connected to a lower end of the first case via a connecting mechanism and accommodates the sub-float valve, the second case having a tubular portion extending in a height direction of the second case, and
a third case which is connected to a lower end of the second case.

2. The float valve for a fuel tank claimed in claim 1, wherein
the tubular portion further extends downwardly beyond a lower end of the first case.

3. The float valve for a fuel tank claimed in claim 1, wherein
the tubular portion is a cylinder that does not accommodate the sub-float valve.

4. The float valve for a fuel tank claimed in claim 1, wherein
the tubular portion has a plurality of ribs.

5. The float valve for a fuel tank claimed in claim 1, wherein
the second case has a partition wall provided with a valve seat for the sub-float valve at a lower end of the tubular portion, and wherein
the second case positions the valve seat below the lower end of the first case.

6. The float valve for a fuel tank claimed in claim 1, wherein
the second case extends so as to shift a central axis of the sub-float valve from a central axis of the main-float valve.

7. A float valve for a fuel tank, the float valve comprising:
a pipe which is disposed to project from an upper part of a fuel tank into the fuel tank so as to define an air passage from an inside of the fuel tank;
a main-float valve which is disposed in the pipe, opens the air passage when there is no fuel in the pipe, and closes the air passage by floating on fuel that has reached the pipe; and
a sub-float valve which is disposed in the pipe closer to the fuel tank than the main-float valve, and restricts an arrival of the fuel to the main-float valve by opening the air passage when the fuel is not present in the pipe and closing the air passage by floating on the fuel that has reached the pipe, wherein
the pipe includes:
a first case for housing the main-float valve; and
a second case which is connected to a lower end of the first case via a connecting mechanism and accommodates the sub-float valve, the second case having a tubular portion extending in a height direction of the second case, wherein
the second case obliquely extends so as to shift a central axis of the sub-float valve from a central axis of the main-float valve.

8. A manufacturing method for a float valve for a fuel tank, the float valve comprising:
a pipe which is disposed to project from an upper part of a fuel tank into the fuel tank so as to define an air passage from an inside of the fuel tank;
a main-float valve which is disposed in the pipe, opens the air passage when there is no fuel in the pipe, and closes the air passage by floating on fuel that has reached the pipe; and
a sub-float valve which is disposed in the pipe closer to the fuel tank than the main-float valve, and restricts an arrival of the fuel to the main-float valve by opening the air passage when the fuel is not present in the pipe and closing the air passage by floating on the fuel that has reached the pipe, the method comprising:
manufacturing a first case which accommodates the main-float valve and forms a part of the pipe;
manufacturing a second case which is connectable to a lower end of the first case via a coupling mechanism, contains the sub-float valve, and forms a part of the pipe; and
connecting the first case and the second case at the coupling mechanism, wherein
the manufacturing the second case manufactures a plurality of the second cases having different heights between the connecting mechanism and the sub-float valve, and wherein
the connecting the first case and the second case connects the second case selected from the plurality of the second cases having different heights to the first case.

9. The manufacturing method for a float valve for a fuel tank claimed in claim 8, wherein
the manufacturing the second case manufactures a plurality of the second cases having different distances between the central axis of the main-float valve and the central axis of the sub-float valve.

10. The manufacturing method for a float valve for a fuel tank claimed in claim 8, wherein
the manufacturing the first case manufactures the first case common to the plurality of different second cases.
